(19) United States
(12) Patent Application Publication
(10) Pub. No.: US 2016/0104584 A1
(43) Pub. Date: Apr. 14, 2016

(54) ELECTRICAL DOUBLE-LAYER CAPACITOR FOR HIGH-VOLTAGE OPERATION AT HIGH-TEMPERATURES

(71) Applicant: Corning Incorporated, Corning, NY (US)

(72) Inventors: Weirong Jiang, Corning, NY (US); Atul Kumar, Horseheads, NY (US); Cameron John Tovey, Painted Post, NY (US)

(21) Appl. No.: 14/878,552

(22) Filed: Oct. 8, 2015

Related U.S. Application Data
(60) Provisional application No. 62/062,496, filed on Oct. 10, 2014.

(51) Int. Cl. H01G 11/62; H01G 11/32; H01G 11/52; H01G 11/24; H01G 11/78; H01G 11/60

(52) U.S. Cl. CPC H01G 11/62; H01G 11/78; H01G 11/60; H01G 11/52; H01G 11/24; H01G 11/32

(57) ABSTRACT

An electrical double-layer capacitor for high-voltage operation at high operating temperatures, includes a housing, carbon positioned in the housing, and electrolyte positioned in the housing. The carbon is activated and includes pores, where the pores in part provide the carbon with a high surface area of at least 500 m²/g. At an operating temperature of the electrical double-layer capacitor of 85° C. at sea level the electrical double-layer capacitor has a voltage output of at least 2.6 V.

### CROSS-REFERENCE

This application claims the priority benefit of U.S. Application No. 62/062,496 filed Oct. 10, 2014, which is incorporated by reference herein in its entirety.

### BACKGROUND

1. Field

The present disclosure relates generally energy storage devices, such as electrical double-layer capacitors, also referred to as electrochemical double-layer capacitors, electric double-layer capacitors, ultra-capacitors, or super-capacitors.

2. Technical Background

Energy storage devices such as electrical double-layer capacitors may be used in a variety of applications such as where a discrete power pulse is required. Example applications range from cell phones to hybrid vehicles. Electrical double-layer capacitors have emerged as an alternative or compliment to batteries in applications that require high power, long shelf life, and/or long cycle life. Electrical double-layer capacitors typically comprise a porous separator and an organic electrolyte sandwiched between a pair of electrodes. The energy storage is achieved by separating and storing electrical charge in the electrochemical double layers that are created at the interfaces between the electrodes and the electrolyte.

Conventional electrical double-layer capacitor may have decreased performance at higher operating temperatures and higher outputs, such as higher voltages. To overcome such decreased performance, some in the industry have moved to specialized electrolytes that do not boil off at the higher temperatures. Additionally, conventional electrical double-layer capacitors may suffer damage and internal wear from high concentrations of electrolyte materials, particularly at higher operating voltages. A need exists for an electrical double-layer capacitor that operates well at high temperatures, and that overcome some or all of the above problems in the art.

### BRIEF SUMMARY

Embodiments include an electrical double-layer capacitor for high-voltage operation at high-temperatures. The electrical double-layer capacitor includes a housing, carbon positioned in the housing, and electrolyte positioned in the housing. The carbon is activated and includes pores, where the pores provide the carbon with a high surface area of at least 500 m²/g. The carbon is a low-oxygen activated carbon having a positive amount of chemically-bonded oxygen content that is less than 1.5% by weight thereof. The electrolyte is a lower-temperature electrolyte having a solvent with a boiling point of less than 85° C. at atmospheric pressure at sea level. Further, the electrolyte is a higher-concentration electrolyte having a molar concentration of at least 1.0 M. At a temperature of the electrical double-layer capacitor of at least 85° C. at sea level (e.g., operating at the temperature of 85° C. or about 85° C. at sea level), (A) the housing of the electrical double-layer capacitor has an internal pressure that is greater than the atmospheric pressure, and (B) the electrical double-layer capacitor has a voltage output of at least 2.6 V (e.g., at least 2.7 V). At higher internal pressures, the boiling point of the electrolyte may increase. At a temperature of the electrical double-layer capacitor of at least 65° C. (e.g., 65° C. or about 65° C.) at sea level the electrical double-layer capacitor has a voltage output of at least 2.9 V.

Applicants understand the voltage of at least 2.6 V at 85° C. to be particularly high relative to conventional electrical double-layer capacitors.

Applicants believe that higher concentrations of electrolyte, such as at least 1.0 M or greater, may facilitate supply of free ions at the high temperatures; whereas Applicants believe that, at the high temperatures, electrolytes with lesser concentrations may have depleted supplies of free electrons resulting in unacceptable equivalent series resistance and/or failure at the high temperatures.

High concentrations of electrolyte may be counter-intuitive to designers of electrical double-layer capacitors for operation at high temperatures because the high-concentration of electrolyte may be believed by the designers to degrade the internal structures of the electrical double-layer capacitors, such as the electrodes. Applicants have discovered that the low-oxygen activated carbon is able to support the higher-concentration electrolyte at high temperatures, such as at least 85° C. (e.g., 85° C.) at atmospheric pressure at sea level, without substantial damage to the electrical double-layer capacitor, such as damage to the degree that may occur with a higher-oxygen content activated carbon.

Further, electrical double-layer capacitors disclosed herein operate at at least 2.9 V at 65° C., which again is particularly high. Embodiments disclosed herein have at least about 70% of initial capacitance and no more than 200% of initial equivalent series resistance after 1500 hours of stress test at at least 2.9 V at at least 65° C. (e.g., 65° C.) at sea level.

Surprisingly, Applicants have discovered that such high voltage outputs may be achieved using conventional lower-temperature electrolytes, such as electrolytes with solvent boiling points that are actually below the operating temperatures of the electrical double-layer capacitor. For example, in some embodiments the electrolyte may be an organic electrolyte that includes a salt, such as tetraethylammonium tetrafluoroborate (TEA-TFB), triethylmethylammonium tetrafluoroborate (TEMA-TFB), or other such electrolyte salt, dissolved in an organic solvent, such as acetonitrile, propylene carbonate, or other solvent. Such electrolytes (i.e., liquid constituents thereof) may have a boiling point of less than 85° C., while the associated electrical double-layer capacitor may achieve voltage outputs of at least 2.6 V when operating at temperatures that are at least 85° C. (e.g., 85° C.). In some such embodiments, special high-temperature electrolytes may be unnecessary to achieve such impressive voltage outputs at the high operating temperatures.

Additional features and advantages of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure, and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is schematic diagram of an EDLC model including Capacitance (C) and Equivalent Series Resistance (ESR).

FIG. 2 is a graphical representation of discharge of an EDLC from and to an open circuit.

FIG. 3 is a graphical representation of ESR characterization using the method of IEC 62391-1 (2006) Section 4.6.2.

FIG. 4 is a graphical representation of ESR characterization using an open-circuit-after-discharge method.

FIG. 5 is a graphical representation of pore volume versus pore size for selected carbons disclosed herein.

FIG. 6 is a graphical representation of capacitance decay in 3 V and 65° C. stress test for EDLC devices containing carbon with different oxygen concentration.

FIG. 7 is a graphical representation of capacitance decay in voltage stress test for EDLC device with different electrolyte concentrations.

FIG. 8 is a graphical representation of ESR as function of voltages at t=0 sec during discharge cycle for selected carbons.

FIG. 9 is a graphical representation of ESR as function of voltages at t=5 sec during discharge cycle for selected carbons.

FIG. 10 is a graphical representation of Ragone plots for EDLC carbon and electrolyte configurations disclosed herein.

FIG. 11 is a graphical representation of high voltage and 65° C. stress test for EDLC with selected carbon disclosed herein.

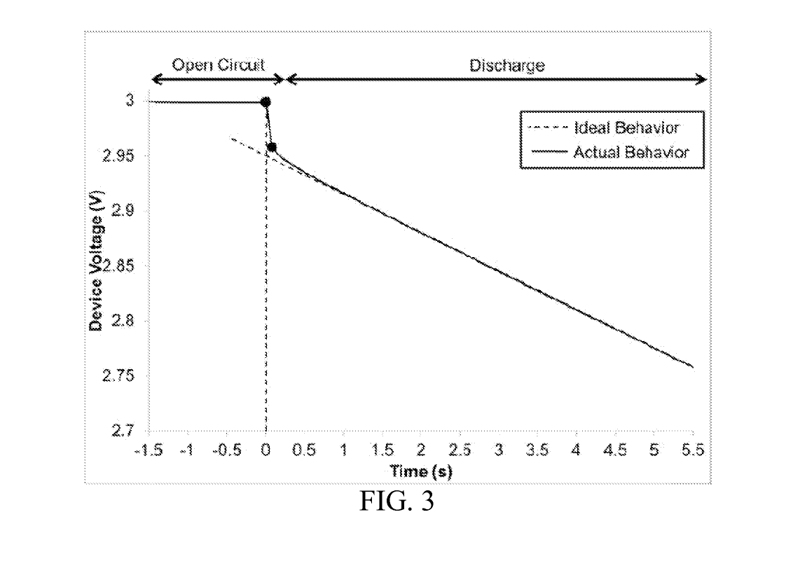

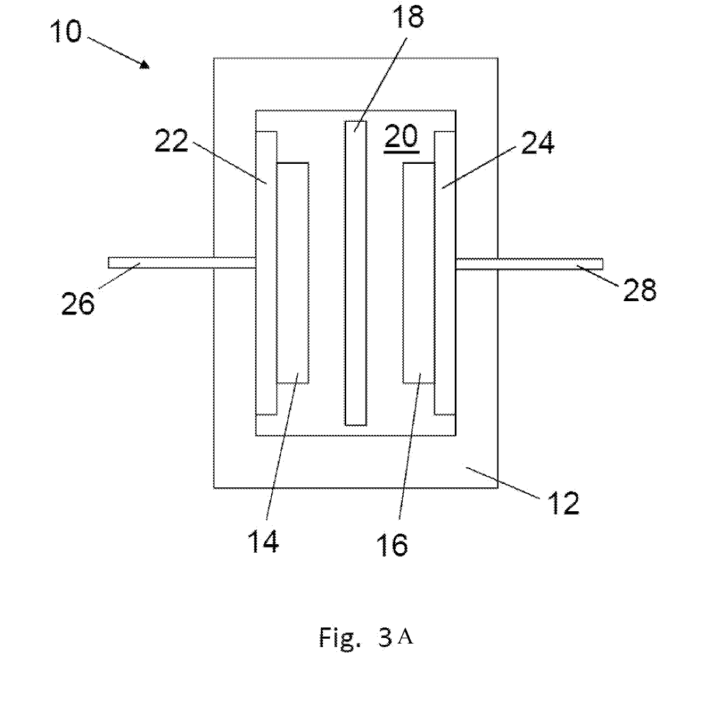

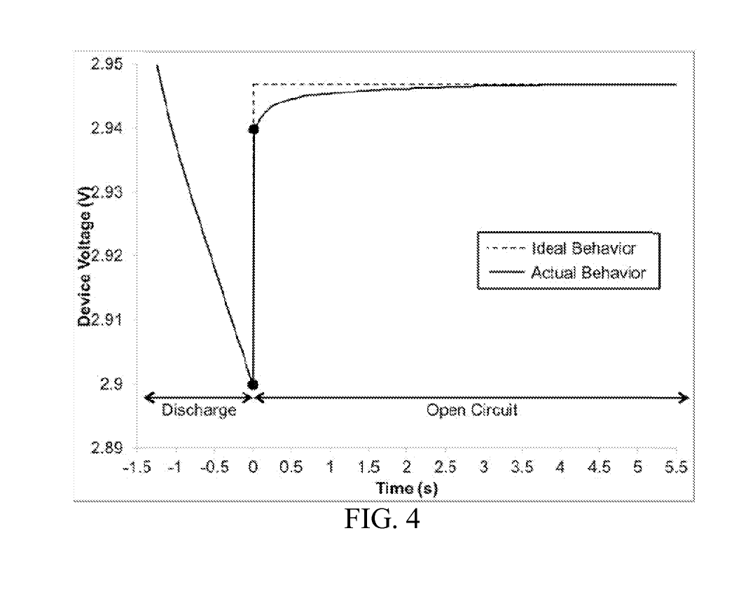

FIG. 3A is a schematic illustration of an example ultracapacitor.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

Technology disclosed herein relates generally to the field of energy storage device product. More specifically, the technology relates to high capacitance, high voltage, and low ESR electric double layer capacitor product utilizing a range of electrolyte concentration. High capacitance may be achieved at least in part by incorporating high surface area alkali activated carbon. High voltage may be achieved at least in part by reducing the amount of surface oxygen functional groups on the carbon. Low ESR may be achieved at least in part by adjusting (e.g., increasing) the electrolyte concentration relative to conventional EDLCs. The combination of these approaches enables a new EDLC device product that has high capacitance, high voltage, and a low ESR at high operating temperatures.

Many conventional EDLC devices utilize low capacitance steam carbon, and these devices may have fair ESR characteristics. Use of high capacitance alkali activated carbon in EDLC devices may lead to significant increase in ESR and consequently, many manufacturers have shied away from using alkali activated carbon for low ESR EDLC devices. Applicants desired to achieve higher energy densities by improving operating voltages. There is a need for a device level solution to enable use of high capacitance alkali carbons.

Also disclosed are methods for characterizing ESR over voltage, which may be for useful characterizing non-constant electrolyte concentration—such as that which decreases as ions are drawn into the carbon to store energy during charging, which may be observed as an increase in device voltage.

According to some embodiments disclosed herein, an EDLC containing low-oxygen alkali activated carbon and high concentration of electrolyte exhibits 20% and higher capacitance than many conventional devices. In some such embodiments, other characteristics such as equivalent series resistance (ESR), self-discharge, and leakage current may be equivalent to many conventional devices.

According to some embodiments disclosed herein, an EDLC containing low-oxygen alkali activated carbon and high concentration of electrolyte exhibit high voltage performance, such as 2.85 V or even 3 V compared to conventional 2.7 V.

According to some embodiments disclosed herein, an EDLC containing a higher concentration of electrolyte exhibits better ESR-Voltage characteristics compared to conventional EDLCs.

According to some embodiments disclosed herein, an EDLC containing a higher concentration of electrolyte may facilitate use of high capacitance alkali activated carbon.

According to some embodiments disclosed herein, an EDLC device can operate at about 2.85 V for about a third increase in energy density (e.g., 39%) and/or at 3 V for about a 50% increase in energy density over state-of-the-art device, such as a 2.7 V rated EDLC with steam carbon.

It is Applicants understanding that conventional EDLC manufacturers have generally not been able to commercialize use of alkali activated carbon in a large format EDLC device. Problems with some alkali activated carbon may include higher degradation in life test, higher initial degradation due to cation trapping in smaller pores, and high ESR. Furthermore, a perceived need to utilize lower concentration of electrolyte to improve voltage performance has been found by Applicants to lead to even higher ESR. All these issues have taught away from use of alkali activated carbon in large format high voltage EDLC device to date.

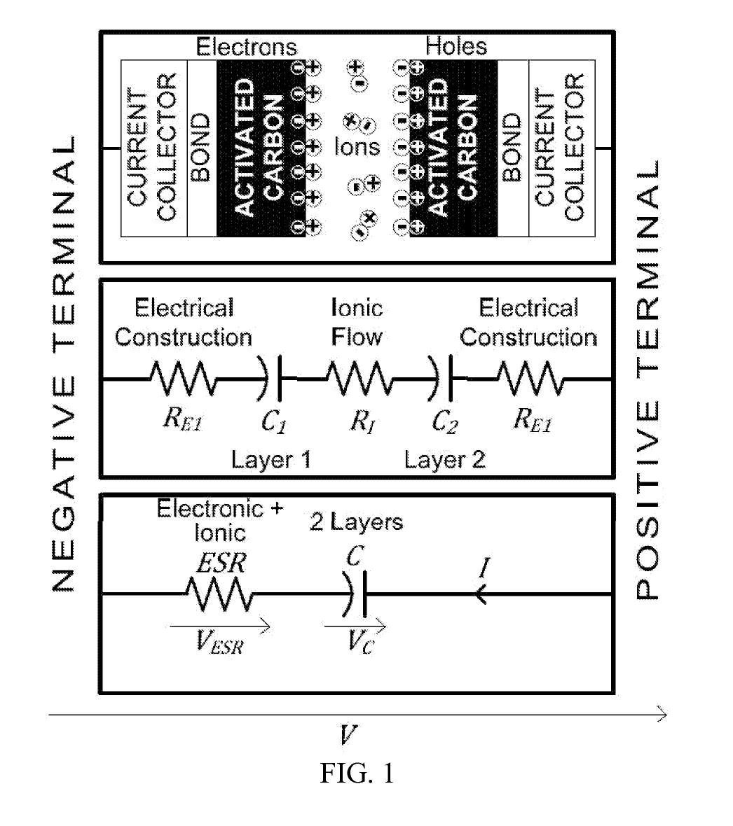

Referring to the top of FIG. 1, according to some exemplary embodiments EDLCs are constructed from two layers of activated carbon, separated, and immersed in electrolyte. Each layer of carbon is bonded to a current carrier, such as an aluminum foil, that provides relatively low resistance for making electrical contact with the carbon, and for conducting electrical current through each carbon layer compared with conduction through the carbon itself. When charged, the carbon layer at the negative terminal gains excess electrons and corresponding positive ions at the surface from the electrolyte; these electron-ion pairs form a first capacitor “C₁” in FIG. 1. At the positive terminal, ion-hole pairs form a second capacitor “C₂”. Electrical resistance due to electron (and hole) conductivity through materials is seen between the carbon and the terminals (R_{E1} and R_{E2}). A model at the bottom of FIG. 1 shows physical and electrostatic resistance of ions to motion as the resistance R₁. Electrically, the model reduces to a single capacitor and single equivalent series resistance (ESR).

Compared with many batteries, EDLCs are rechargeable devices exhibiting significantly high power but with significantly lower energy density. EDLCs are typically classed as power devices not energy devices, for use in applications where the ability to supply or absorb energy very rapidly (but for a short time) may be required. While it is capacitance and voltage that primarily affect energy, the ESR affects power performance.

EQ.1 and EQ.2 are the voltage equations respectively for the capacitor and ESR in FIG. 1. The resulting voltage equation is EQ.3.

$$\begin{matrix}Δ {V}_{CAP} ( t ) = \frac{1}{C} {\int }_{0}^{t} I ( t ) d t & EQ . 1 \\ {V}_{ESR} ( t ) = I ( t ) E S R & EQ . 2 \\ V ( t ) = I ( t ) E S R + \frac{1}{C} {\int }_{0}^{t} I ( t ) d t + V ( 0 ) & EQ . 3\end{matrix}$$

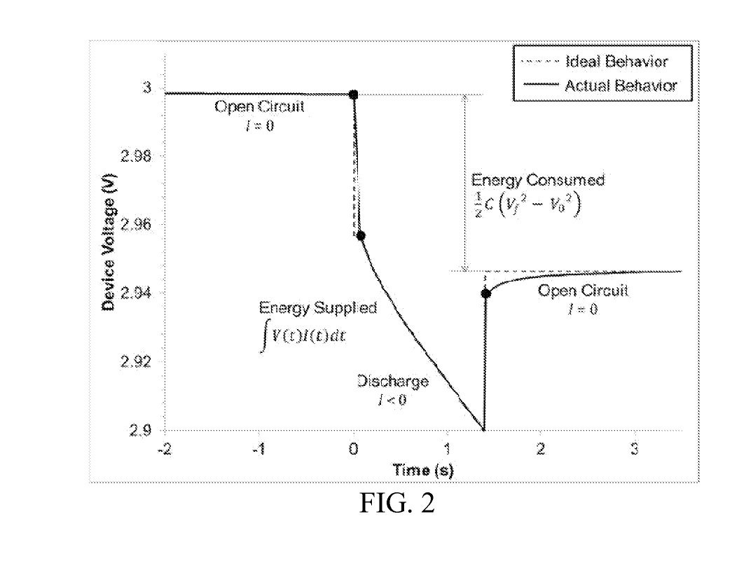

It follows from EQ.3 that the electrical current (I) influence cell voltage; charging the capacitor (voltage) smoothly, and causes instantaneous voltage change in the resistor. When a discharge occurs to supply power from rest, the result has the form of FIG. 2. The discontinuities in voltage at t=0 and t=1.36 sec result from the ESR.

One method of measuring ESR is to use power balancing. The energy of a capacitor is ½CV²; and with the capacitance, one can calculate energy lost, as shown in FIG. 2. One can also measure the energy actually supplied by the capacitor during a test by integrating P=VI. The difference between the two values is the result of the ESR; specifically, the power loss is the integral P=V(t)I(t) for the ESR only, where V(t)=I(t)ESR (see EQ.2). The capacitance is also estimable from the energy, and the result is independent from the ESR. The energy cancels out of the equation, and the ESR is generally a function of the voltage discontinuities and the current. From EQ.3, over the voltage discontinuity:

$$E S R = \frac{Δ V}{Δ I} \qquad EQ . 4$$

Specifically, IEC 62391-1 (2006) Section 4.6.2 calculates ESR as shown in FIG. 3 and described below. First, from EQ.3 if discharge is at constant current, then the discharge part of the curve should be a line. The IEC method is for a state where the current is so small as to have insignificant impact. The IEC method accounts for non-ideal ESR behavior by finding where the curve becomes straight, and extrapolating back to find an assumed equivalent voltage at the start of discharge, which is used in EQ.4. One issue with this method is that it assumes that the capacitance is constant, and there are no other voltage driven effects—the non-linearity in the discharge voltage-time curve may not be an ESR effect at all.

To see the impact of ESR on power with voltage, note that if the EDLC is discharge to half voltage, the electrical current doubles to maintain power. As previously mentioned, power loss due to ESR is P=I²(t)ESR, so doubling the current results in a four-fold increase in power loss. Therefore when discharging to low voltages, energy returns are quickly diminished (for example, a discharge to 10% of the voltage discharges 99% of the stored energy but with a final power lost at 100 times that of the start of discharge), so unless the EDLC is used in low power mode much of that additional energy is lost. It should be noted that those using Pulse-Width-Modulation (PWM), where a fixed current is switched on and off at different rates to draw constant power, may see power loss due to ESR increase linearly with reduced voltage instead of the aforementioned squared relationship. However, in both cases, a Applicants find that having a low ESR is between two and four times more important at half-voltage than at full voltage in many applications.

According to exemplary embodiments, an EDLC as disclosed herein may include a unique combination of following elements.

(a) Use of alkali activated carbon versus state-of-the-art steam activated carbon

(b) Use of low-oxygen activated carbon versus high-oxygen activated carbon

(c) Use of high-concentration electrolyte versus low-concentration electrolyte

In one example carbons and electrolyte were evaluated in large format EDLC device. The activated carbon was first mixed with PTFE binder and Carbon Black in the ratio of 85:10:5 in high intensity Henschel shear mixer (FML 10 fitted with double helical blunt blades) at 5° C. The mixing speed rpm was set at 2000 rpm and mixing time was 40 min. Around 5% IPA by weight was introduced in the mix after 35 min of dry mixing, followed by an additional 5 min wet mixing. IPA was added during mixing step to aid in fibrillization. After the electrode constituents were uniformly dispersed and distributed, fibrillization was performed. A 4 inch micronizer jet mill with tungsten carbide lining was used for the fibrillization process. The material was sieved through a 10 mesh screen to break clumps before feeding into the jet mill. A feed pressure was set to 70 psi, grind pressure to 85 psi and feed rate to 1020 g/hr. The powder obtained from micronizer was de-agglomerated using a swifter. The de-agglomerated mix was then calendared by passing it through series of pressure rollers at 100° C. forming a 100 μm thick free stand-alone sheet. Two of these free standing carbon webs were laminated on each side of conductive carbon ink-coated current collector to obtain an electrode. The current collector is a 25 μm thick aluminum foil with around 5 μm thick coating of conductive carbon ink (DAG EB012 from Henkel, formerly Acheson). Two of such electrodes (negative electrode with YP50 carbon and positive electrode with alkali activated microporous carbon), separated by a porous separator paper (e.g., TF4030 from Nippon Kodoshi Corporation) were winded into a jelly roll and packaged/sealed in aluminum can to form EDLC device. The device was vacuum dried at 130° C. for 48 hrs before filled with the predetermined concentration and amount of electrolyte. The cell was electrochemically conditioned and then tested for further evaluation.

### High Surface Area Alkali Activated Carbon

The steam activated carbon is a prevalent method for making activated carbon. However, carbon pore size distribution obtained with steam activation may not be amenable for EDLCs because, to date, many commercial manufacturers of activated carbon have not been able to achieve carbon performance beyond 67 F/cc with coconut char as a carbon precursor.

The chemical activation process has been utilized to create high surface area activated carbon. Several chemicals have been used, including KOH, NaOH, LiOH, H₃PO₄, Na₂CO₃, KCl, NaCl, MgCl₂, AlCl₃, P₂O₅, K₂CO₃, K₂S, KCNS, and/or ZnCl₂; however, use of alkali metal hydroxides, such as KOH and NaOH may be preferred to achieve various desirable properties. Carbon precursors include coconut shell, macadamia nuts, wheat flour, coal, and coke. In some cases such as with coconut shell, macadamia nuts, and wheat flour, a carbonization step facilitates removal of most non-carbon elements, such as hydrogen, oxygen, traces of sulfur and nitrogen. The process involves heating the carbon in an inert N₂ atmosphere to remove the non-carbon elements. The atoms of elementary carbon, thus released, are grouped into organized crystallographic formations known as elementary graphitic crystallites. The mutual arrangements of these crystallites may be irregular, so that free interstices remain between them, and as the result of deposition and decomposition of tarry substances, these free interstices may become filled or blocked by disorganized carbon. In cases of coal and coke precursors, the carbonization step may be skipped since these materials contain large amounts of fixed carbon (such as about 90 wt. %). Activation is performed by mixing KOH solid powder with the carbonized powder in the desired ratio and heating the mixture during the activation cycle. In some cases a pellet may be formed with KOH and carbonized powder to aid in activation process. At higher temperatures (such as >700° C.), metallic potassium intercalates into the carbon matrix, and after washing, creates micro-porosity in the matrix.

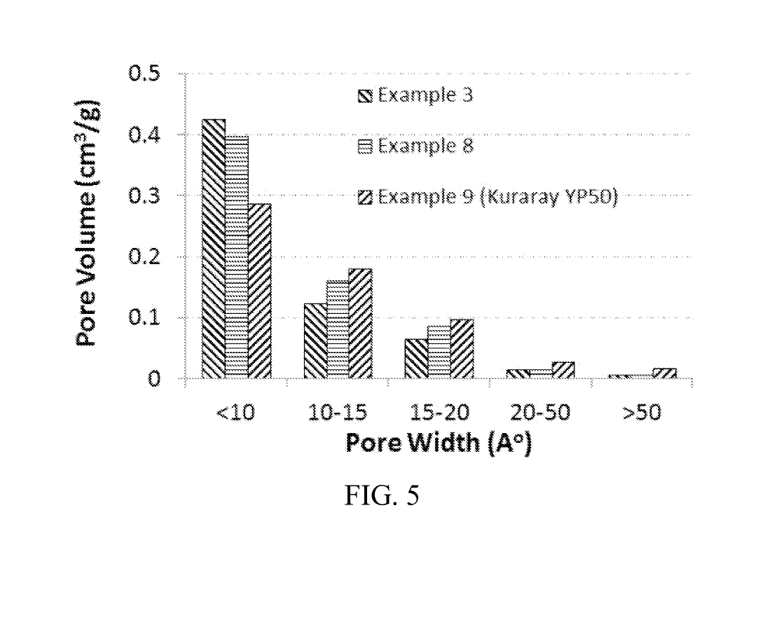

The carbon produced from such a method has high BET surface area of 1700-2500 m²/g compared to 1600 m²/g for the steam carbon. Although, the overall pore volume of alkali activated carbon is similar or greater than steam carbon, the former has greater amount of pores (such as >0.3 cm³/g) in less than 1 nm pore diameter range compared to steam carbon (such as <0.3 cm³/g) (see FIG. 5). The greater amount of pores in less than 1 nm range for alkali carbon may lead to high volumetric capacitance in excess of 80 F/cc. Such a carbon may provide a high energy density in an EDLC device compared to state-of-the-art steam device.

### Low Oxygen Alkali Activated Carbon

Oxygen is present in activated carbon in the form of surface functional groups. The surface functional groups are composed of heteroatoms, that are mainly oxygen and hydrogen, and to a lesser degree nitrogen, sulfur and halogens. These heteroatoms are either derived from starting carbon precursor or acquired externally in activation or other processes. The functional groups affect the wettability and electrochemical state of the carbon surface and its double layer properties such as self-discharge characteristics.

The above mentioned heteroatoms include carbon-oxygen complexes. Many of the oxygen functional groups are formed during activation, which is essentially a partial oxidation process. Activated carbons can physisorb molecular oxygen upon exposure to air, even at sub-ambient temperatures. The chemical adsorption also begins at low temperature and increases with temperature. Different functional groups can be acidic, basic, and neutral. Acidic functional groups are the least stable and can be formed when carbons are exposed to oxygen between 200 and 700° C. or by reactions with oxidizing solutions at room temperature. The level of oxygen retained in carbon (either physisorbed or chemisorbed) is proportional to EDLC self-discharge or leakage current and ultimately affect the lifetime characteristics. The oxygen functional groups serve as active sites which can catalyze or participate in electrochemical oxidation or reduction of carbon and/or decomposition of electrolyte components. Removal of oxygen from carbon generally improves their stability in EDLC environment.

The oxygen content of activated carbon can be reduced by heat-treatment a reducing environment at high temperatures. The process which is carried in forming gas (1% H₂/N₂) environment reduces the oxygen containing functional groups on carbon surface to improve its long term durability in EDLC. The activated carbon is placed in SiC crucibles and loaded into a furnace. The furnace temperature is increased at a heating rate of 150° C./hr to desired temperature (400, 675 or 900° C.), maintained at temperature for 2 hours, and then allowed to cool down naturally. During the foregoing heating/cooling cycle, the furnace is constantly purged with forming gas. Table 1 shows the oxygen content for the carbons disclosed, while Table 2 shows the amount of acidic surface functional groups obtained through Boehm titration on selected carbons. High temperature heat treatment leads to reduction in surface functional groups on the carbon.

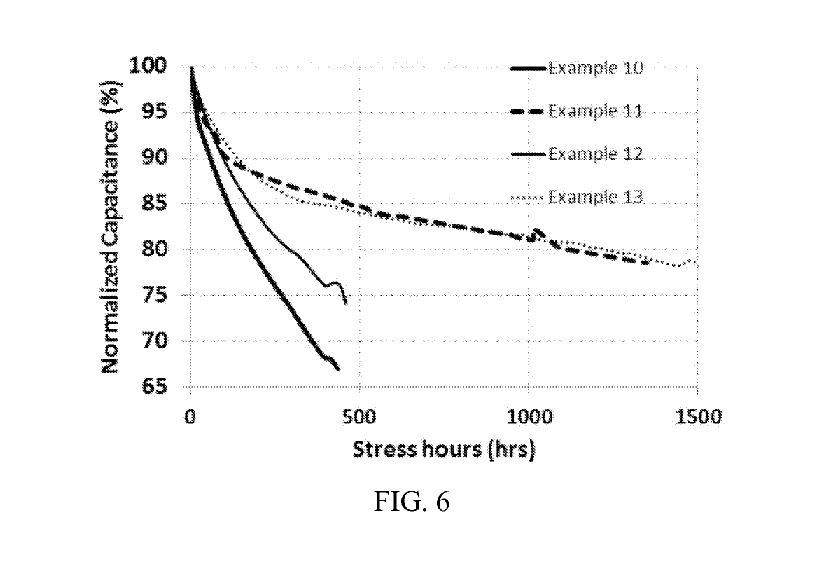

Table 3 shows beginning of life data for EDLC devices containing carbon with different oxygen content. Example 10 depicts an EDLC device with high oxygen KOH activated carbon and 1.2 M concentration of TEMA-BF4 electrolyte. The BOL capacitance is 3156 F and ESR at rated voltage is 0.65 mΩ. The device fails prematurely in a 3 V-65° C. stress test, degrading to 75% normalized capacitance at 275 hours. Example 11 shows an EDLC device containing low oxygen KOH activated carbon and 1.2 M concentration of TEMA-BF4 electrolyte. The BOL capacitance is 3010 F and ESR at rated voltage is 0.50 mΩ. The device achieves 78% normalized capacitance at 1350 hours. This example shows effect of carbon oxygen content in surface functional groups on EDLC degradation in voltage stress test. Similarly, Example 12 shows a tuned cell configuration containing high oxygen KOH carbon on positive electrode and as-received YP50 carbon on negative electrode, and containing 1.2 M concentration of TEMA-BF4 electrolyte. The BOL capacitance is 2930 F and ESR at rated voltage is 0.44 mΩ. The device fails prematurely in a 3 V constant voltage stress test. Example 13 shows similar tuned cell configuration as above but with low-oxygen containing carbon. The BOL capacitance is 2883 F and ESR at rated voltage is 0.43 mΩ. The device achieves 78% normalized capacitance at 1500 hours. The experiment shows that low oxygen carbon improves the high voltage stability of an EDLC device. The 3 V-65° C. stress data is shown in FIG. 6.

### High Electrolyte Concentration

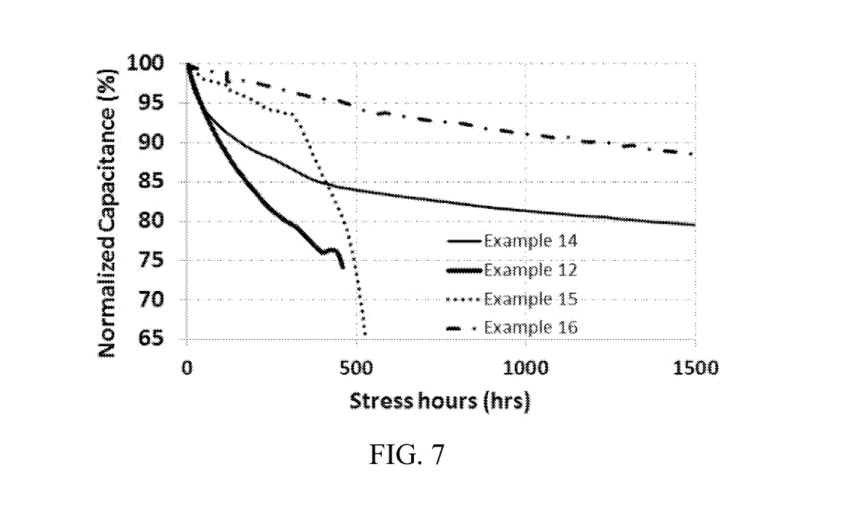

Higher voltage facilitates higher energy density. Since energy density is proportional to square of operating voltage, an increase from 2.7 V to 3 V leads to 23% increase in energy density. One approach to increase operating voltage is to reduce the electrolyte concentration. Lower concentration of electrolyte leads to less faradic reactions at higher voltages and lowers the degradation of the EDLC device. Consequently, lower electrolyte concentration improves the voltage performance. However, this comes at the expense of ESR penalty. Table 4 shows the beginning of life data for EDLC with different concentrations of electrolyte, and FIG. 7 shows the corresponding capacitance decay in voltage stress test. The device configuration utilized is tuned cell configuration as disclosed in U.S. Publication No. 2012/0257326. The tuned cell configuration includes first and second carbon materials having distinct pore size distributions, where a pore volume ratio of the first carbon material is greater than a pore volume ratio of the second carbon material, the pore volume ratio R defined a R=V1/V, where V1 is a total volume of pores having a pore size of less than 1 nm, and V is total volume of pores having a pore size greater than 1 nm. The first carbon is KOH activated carbon and second carbon is steam activated carbon (YP50F), such as that commercially available from Kuraray Chemicals. The oxygen content for both these carbon types is in between 1 to 1.5 wt %.

Example 14 shows a tuned cell configuration containing 1.2 M concentration of TEMA-BF4 electrolyte. The BOL capacitance is 2921 F and ESR at rated voltage is 0.46 mΩ. The normalized capacitance in a 2.7 V constant voltage stress test after 1500 hours is around 80%. The same device when tested in a 3 V constant voltage stress test fails prematurely (80% normalized capacitance at around 300 hrs) (Example 12). Example 15 shows tuned cell configuration with reduced electrolyte concentration of 0.9 M. The BOL capacitance is 2948 F and ESR at rated voltage is 0.53 mΩ. In this example, that decrease in electrolyte concentration impacts the rated voltage ESR in a detrimental manner. This device also fails prematurely with 80% normalized capacitance at 450 hours—slightly better than Example 12. Example 16 shows tuned cell configuration with further reduced electrolyte concentration of 0.6 M. The BOL capacitance is 2901 F and ESR at rated voltage is 3.09 mΩ. The high ESR at rated voltage is due to very low concentration of electrolyte utilized in the device. While the ESR at rated voltage is high, such a device performs extremely well at 3 V in constant voltage stress test (88% normalized capacitance at 1500 hours). The experiment shows that while high voltage performance can be achieved by lowering of electrolyte concentration, the device ESR increase significantly as well. Since EDLC are power devices, such an approach might not be practical unless the increase in ESR is compensated via other methods (such as adding more carbon black, increasing electrode area, etc.).

### Integration of Alkali Activated—Low Oxygen Carbon and High Concentration Electrolyte

Aspects of the present technology are based on the unique combination of alkali activated—low oxygen carbon with high concentration electrolyte. Surprisingly the inventors have discovered that these three elements can be combined to achieve a high capacitance, high voltage and low ESR electric double layer capacitor. Such a device has superior energy and power density capabilities compared to the state-of-the-art device. The use of alkali activated carbon instead of steam activated carbon provides 20% and higher volumetric capacitance. The use of low-oxygen (0.2-0.8 wt %) alkali activated carbon faciliates high voltage operation such as 2.85 V or 3 V. The concentration of electrolyte is set in range of 10-20 mM per unit volumetric capacitance. The inventors have found that lower electrolyte concentration, especially with high capacitance carbon significantly increases the ESR at rated voltage, and mildly increases the ESR at half-rated voltage. At higher concentrations such as 1.5 M, the benefits of increase in electrolyte conductivity flatten out, and capacitance degradation may be higher due to faradaic reactions.

The technology will be further clarified with the following examples.

### Example 17

Example 17 depicts an EDLC device containing commercial available steam activated carbon YP50F. The oxygen content for YP50F is around 1.5 wt %. The device contains 0.8 M concentration of TEA-BF4 electrolyte, and achieves a volumetric capacitance of 67.1 F/cc. The total ions required for full charge to 2.85 V is calculated as 0.07 moles (=2381×2.85/96485). The total ions in the electrolyte is calculated as 0.10 moles (=0.8×130/1000). Therefore, the excess ions in the electrolyte is calculated as 0.03 moles (=0.10−0.07). The excess molarity is calculated to be 0.26 M (=0.03/130×1000). The concentration of electrolyte per unit volumetric capacitance is calculated to be 11.9 mM per F/cc. The ESR at rated voltage is 0.55 mΩ and at half-rated voltage is 0.38 mΩ. The device is capable of operation at 2.85 V-65° C. for 1500 hours.

### Example 18

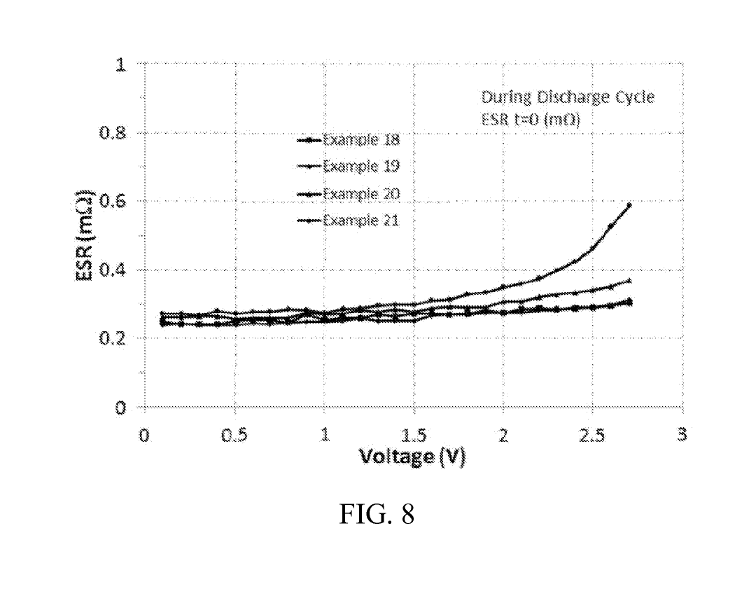

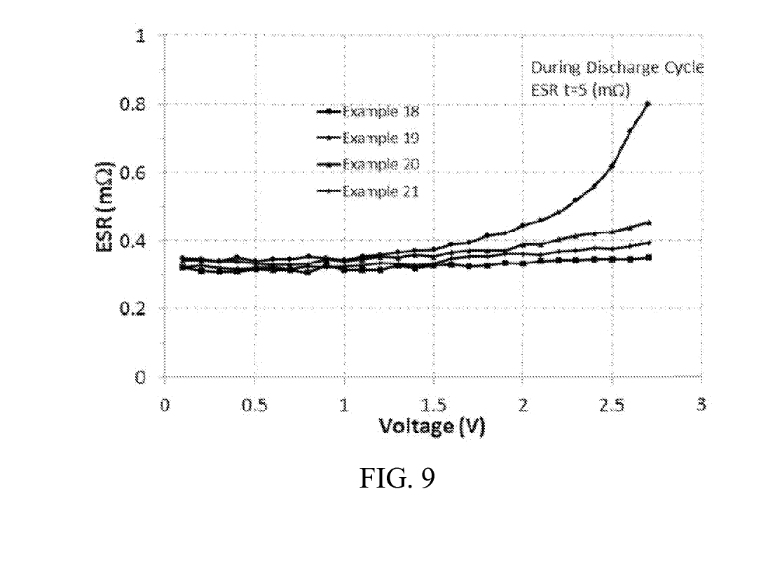

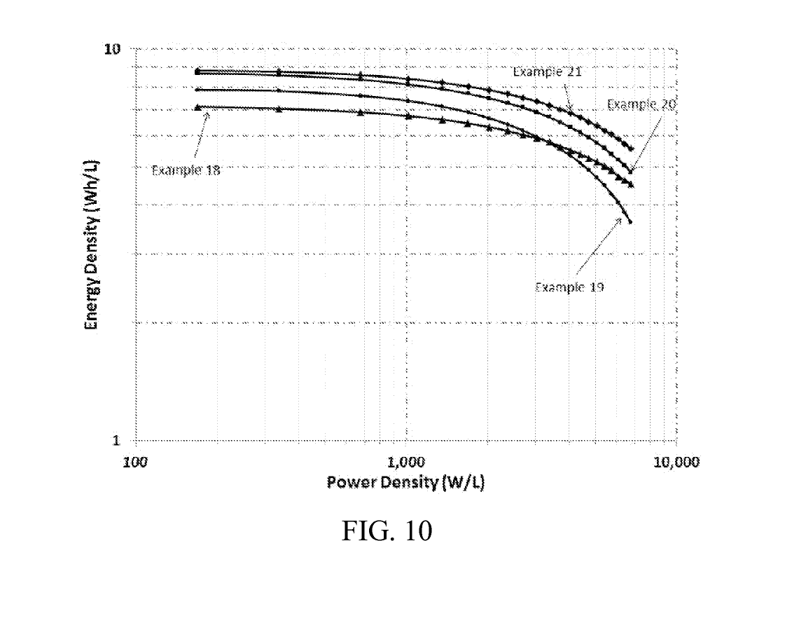

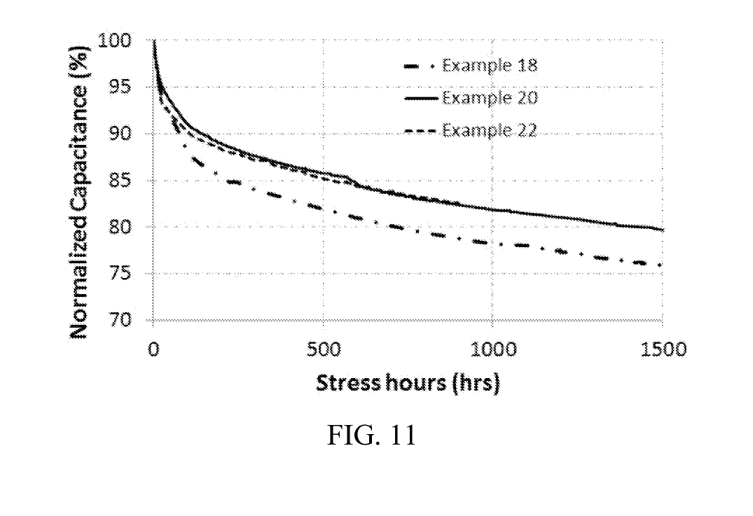

Example 18 is similar to example 17, except the electrolyte concentration is changed to 1 M. The device achieves a volumetric capacitance of 66.2 F/cc. The concentration of electrolyte per unit volumetric capacitance is calculated to be 15.1 mM per F/cc. The ESR at rated voltage is 0.39 mΩ and at half-rated voltage is 0.27 mΩ. This example can be compared to Example 17 and demonstrates the improvement in ESR with electrolyte concentration for steam carbon. The ESR versus voltage characteristics are shown in FIGS. 8 and 9, and show a relatively flat ESR for range of voltages. FIG. 10 shows the Ragone plot for the device for Example 18. The device is capable of achieving 7 Wh/L at lower power densities, and falls off to 4.5 Wh/L at high power densities. FIG. 11 shows 2.85 V-65° C. stress data, achieving 76% normalized capacitance at 1500 hours.

### Example 19

Example 19 depicts an EDLC device containing KOH activated carbon. The oxygen content in this carbon is around 0.54 wt %. The device contains 0.8 M concentration of TEA-BF4 electrolyte, and achieves a volumetric capacitance of 80.7 F/cc. The total ions required for full charge to 2.85 V is calculated as 0.085 moles. The total ions in the electrolyte are calculated as 0.10 moles. Therefore, the excess ions in the electrolyte are calculated as 0.02 moles. The excess molarity is calculated to be 0.15 M. The concentration of electrolyte per unit volumetric capacitance is calculated to be 9.9 mM per F/cc. The ESR at rated voltage is 0.92 mΩ and at half-rated voltage is 0.31 mΩ. This example can be compared to Example 18, and shows a high ESR, both at rated voltage and half-rated voltage. The ESR versus voltage characteristics (FIGS. 8 and 9) show an increasing ESR at higher voltages and are due to low level of electrolyte concentration per unit volumetric capacitance. The Ragone plot (FIG. 10) shows a lower energy density compared to Example 18 for higher power densities. Additionally, the device is capable of operation at 2.85 V for 1500 hours.

### Example 20

Example 20 is similar to example 19, except the electrolyte concentration is changed to 1 M. The device achieves a volumetric capacitance of 80.4 F/cc. The concentration of electrolyte per unit volumetric capacitance is calculated to be 12.4 mM per F/cc. The ESR at rated voltage is 0.53 mΩ and at half-rated voltage is 0.28 mΩ. This example can be compared to Example 19, and shows a low ESR, both at rated voltage and half-rated voltage. The ESR versus voltage characteristics (FIGS. 8 and 9) show a slightly increasing ESR at higher voltages and are due to low level of electrolyte concentration per unit volumetric capacitance. The Ragone plot (FIG. 10) shows a higher energy density compared to Example 18 and 19 for the range of power tested. Additionally, the device is capable of operation at 2.85 V-65° C., and achieves 80% normalized capacitance at 1500 hours (FIG. 11).

### Example 21

Example 21 is similar to example 19, except the electrolyte concentration is changed to 1.2 M. The device achieves a volumetric capacitance of 80.5 F/cc. The concentration of electrolyte per unit volumetric capacitance is calculated to be 14.9 mM per F/cc. The ESR at rated voltage is 0.47 mΩ and at half-rated voltage is 0.26 mΩ. This example can be compared to Examples 19 and 20, and shows a low ESR, both at rated voltage and half-rated voltage. The ESR versus voltage characteristics (FIGS. 8 and 9) show a relatively flat ESR with voltage and are due to low level of electrolyte concentration per unit volumetric capacitance. The Ragone plot (FIG. 10) shows a higher energy density compared to Example 18-20 for the range of power tested. Additionally, the device is capable of operation at 2.85 V for 1500 hours.

### Example 22

Example 22 is similar to example 21, except the electrolyte type is changed to TEMA-BF4. The device achieves a volumetric capacitance of 83 F/cc. The concentration of electrolyte per unit volumetric capacitance is calculated to be 14.5 mM per F/cc. The ESR at rated voltage is 0.43 mΩ and at half-rated voltage is 0.27 mΩ. This example can be compared to Example 21, and shows similar ESR, both at rated voltage and half-rated voltage. Additionally, the device is capable of operation at 3 V-65° C. (FIG. 11).

### Example 23

Example 23 depicts a tuned cell EDLC configuration with KOH carbon on the positive electrode and YP50 steam carbon on the negative electrode. The KOH carbon and steam carbon has 0.24 wt % and 0.18 wt % oxygen, respectively. The device was filled with 1.2 M TEMA-BF4 electrolyte. The device achieves a volumetric capacitance of 74 F/cc, and is lower compared to Examples 19-22. The concentration of electrolyte per unit volumetric capacitance is calculated to be 16.2 mM per F/cc. The ESR at rated voltage is 0.43 mΩ and at half-rated voltage is 0.31 mΩ, and are similar to Example 21 and 22. The device is capable of operation at 3 V for 1500 hours.

### Example 24

Example 24 is similar to example 20, except the device has 25% shorter electrode length in the jelly roll. The device achieves a volumetric capacitance of 82.1 F/cc. The concentration of electrolyte per unit volumetric capacitance is calculated to be 12.2 mM per F/cc. The ESR at rated voltage is 0.67 mΩ and at half-rated voltage is 0.33 mΩ. The example can be compared to Example 20 and shows around 25% higher ESR (both at rated voltage and half-rated voltage). This is due to 25% smaller electrode area. The example also shows that larger volume of electrolyte does not improve rated voltage and half-rated voltage ESR.

TABLE 1

| | | | | | | Relative | |
|---|---|---|---|---|---|---|---|
| | | | | | Heat | Capacitance | |
| | | | Activation | | Treatment | Advantage | Oxygen |
| | | KOH/C | Temperature | Activation | Temperature | over | Content |
| Example # | Precursor | Ratio | (C.) | Time (hr) | (C.) | Baseline (%) | (wt %) |
| Example 1 | Green | 2:1 | 850 | 1 | No heat | 41.4 | 3.86 |
| | Coke | | | | treatment | | |
| Example 2 | Green | 2:1 | 850 | 1 | 400 | 40.9 | 3.3 |
| | Coke | | | | | | |
| Example 3 | Green | 2:1 | 850 | 1 | 900 | 20.2 | 0.54 |
| | Coke | | | | | | |
| Example 4 | Green | 2:1 | 850 | 1.5 | 400 | 37.9 | Not |
| | Coke | | | | | | available |
| Example 6 | Wheat | 2.2:1 | 750 | 2 | No heat | Not | Not |
| | | | | | treatment | available | available |
| Example 7 | Wheat | 2.2:1 | 750 | 2 | 675 | Not | Not |
| | | | | | | available | available |
| Example 8 | Wheat | 2.2:1 | 750 | 2 | 900 | 17.8 | 0.24 |

| | | | | |
|---|---|---|---|---|
| Example 9 | Coconut | as-received | Baseline | 1.37 |
| (Kuraray | Shell | | | |
| YP50) | | | | |

| | | DFT | | | | | |
|---|---|---|---|---|---|---|---|
| | BET | Total | | | | | |
| | Surface | Pore | | | | | |
| | Area | Volume | V_{<=10 A} | V_{10-15 A} | V_{16-20 A} | V_{20-50 A} | V_{50-200 A} |
| Example # | (m²/g) | (cm³/g) | (cm³/g) | (cm³/g) | (cm³/g) | (cm³/g) | (cm³/g) |
| Example 1 | 1810 | 0.626 | 0.428 | 0.120 | 0.054 | 0.015 | 0.007 |
| Example 2 | 1525 | 0.616 | 0.406 | 0.131 | 0.058 | 0.016 | 0.005 |
| Example 3 | 1839 | 0.632 | 0.425 | 0.122 | 0.065 | 0.015 | 0.005 |
| Example 4 | 1541 | 0.627 | 0.399 | 0.132 | 0.065 | 0.029 | 0.003 |
| Example 6 | 2119 | 0.725 | 0.486 | 0.153 | 0.070 | 0.013 | 0.005 |
| Example 7 | 2087 | 0.712 | 0.432 | 0.173 | 0.086 | 0.013 | 0.008 |
| Example 8 | 1913 | 0.661 | 0.396 | 0.159 | 0.086 | 0.015 | 0.005 |
| Example 9 | 1586 | 0.605 | 0.286 | 0.179 | 0.096 | 0.027 | 0.016 |
| (Kuraray | | | | | | | |
| YP50) | | | | | | | |

TABLE 2

| | | NaOH | | | | |
|---|---|---|---|---|---|---|
| | | Carboxylic + | Na2CO3 | | | |
| | Base | lactonic + | Carboxylic + | NaHCO3 | NaOH—Na2CO3 | Na2CO3—NaHCO3 |
| Example # | Groups | phenolic | lactonic | Carboxylic | Phenol | Lactonic |
| Example 1 | mmol/g | 0.66 | 0.29 | 0.09 | 0.36 | 0.2 |
| Example 2 | mmol/g | 0.74 | 0.37 | 0.15 | 0.37 | 0.22 |
| Example 3 | mmol/g | 0.25 | 0.09 | 0.05 | 0.17 | 0.04 |

TABLE 3

| | | | Total | | | | | BOL ESR |
|---|---|---|---|---|---|---|---|---|
| | | Carbon | Carbon | | Electrolyte | Operating | BOL | at Rated |
| | | Oxygen | Volume | | Fill | Voltage | Capacitance | Voltage |
| Example # | Cell Configuration | (wt %) | (cc) | Electrolyte | Volume | (V) | (F) | (mΩ) |
| Example 10 | KOH Symmetric Cell | 0.88 | 151 | 1.2M TEMA-BF4 | 130 | 3.0 | 3156 | 0.65 |
| Example 11 | KOH Symmetric Cell | 0.24 | 144 | 1.2M TEMA-BF4 | 125 | 3.0 | 3010 | 0.50 |
| Example 12 | KOH(+)/YP50(−) Tuned Cell | 0.88/1.37 | 150 | 1.2M TEMA-BF4 | 130 | 3.0 | 2930 | 0.44 |
| Example 13 | KOH(+)/YP50(−) Tuned Cell | 0.24/0.18 | 154 | 1.2M TEMA-BF4 | 130 | 3.0 | 2883 | 0.43 |

TABLE 4

| | | Total | | Electrolyte | | | BOL ESR |
|---|---|---|---|---|---|---|---|
| | | Carbon | | Fill | Operating | BOL | at Rated |
| | | Volume | | Volume | Voltage | Capacitance | Voltage |
| Example # | Cell Configuration | (cc) | Electrolyte | (ml) | (V) | (F) | (mΩ) |
| Example 14 | KOH(+)/YP50(−) Tuned Cell | 151 | 1.2M TEMA-BF4 | 130 | 2.7 | 2921 | 0.46 |
| Example 12 | KOH(+)/YP50(−) Tuned Cell | 150 | 1.2M TEMA-BF4 | 130 | 3.0 | 2930 | 0.44 |
| Example 15 | KOH(+)/YP50(−) Tuned Cell | 150 | 0.9M TEMA-BF4 | 130 | 3.0 | 2948 | 0.53 |
| Example 16 | KOH(+)/YP50(−) Tuned Cell | 150 | 0.6M TEMA-BF4 | 130 | 3.0 | 2901 | 3.09 |

TABLE 5

| | | | | Total | | | | | |
|---|---|---|---|---|---|---|---|---|---|
| | | | | Carbon | | | Electrolyte | | BOL |
| | | Oxygen | Cell | Volume | Electrolyte | Concentration | Fill Volume | Operating | Capacitance |
| Example # | Carbon | Content | Configuration | (cc) | Type | (M) | (ml) | Voltage | (F) |
| Example 17 | YP50 | 1.5 | YP50(+)/YP50(−) | 142 | TEA-BF4 | 0.8 | 130 | 2.85 | 2381 |
| | | | Symmetric Cell | | | | | | |
| Example 18 | YP50 | 1.5 | YP50(+)/ | 142 | TEA-BF4 | 1 | 130 | 2.85 | 2350 |
| | | | Symmetric Cell | | | | | | |
| Example 19 | KOH | 0.54 | KOH(+)/KOH(−) | 142 | TEA-BF4 | 0.8 | 130 | 2.85 | 2864 |
| | | | Symmetric Cell | | | | | | |
| Example 20 | KOH | 0.54 | KOH(+)/KOH(−) | 142 | TEA-BF4 | 1 | 130 | 2.85 | 2853 |
| | | | Symmetric Cell | | | | | | |
| Example 21 | KOH | 0.54 | KOH(+)/KOH(−) | 142 | TEA-BF4 | 1.2 | 130 | 2.85 | 2858 |
| | | | Symmetric Cell | | | | | | |
| Example 22 | KOH | 0.54 | KOH(+)/KOH(−) | 142 | TEMA-BF4 | 1.2 | 130 | 3.00 | 2947 |
| | | | Symmetric Cell | | | | | | |
| Example 23 | KOH, | 0.24, | KOH(+)/YP50-L(−) | 148 | TEMA-BF4 | 1.2 | 130 | 3.00 | 2738 |
| | YP50-L | 0.18 | Tuned Cell | | | | | | |
| Example 24 | KOH | 0.54 | KOH(+)/KOH(−) | 104 | TEA-BF4 | 1 | 130 | 2.85 | 2136 |
| | | | Symmetric Cell | | | | | | |

| | | Total Ions | | | | | | BOL ESR |
|---|---|---|---|---|---|---|---|---|
| | BOL | Required | Total Ions | Excess Ions | | Ions in | BOL ESR | at Half- |
| | Volumetric | for Full | in | in | Excess | Electrolyte | at Rated | Rated |
| | Capacitance | Charge | Electrolyte | Electrolyte | Molarity | per Farad | Voltage | Voltage |
| Example # | (F/cc) | (moles) | (moles) | (moles) | (M) | (mM(/F/cc)) | (mΩ) | (mΩ) |
| Example 17 | 67.1 | 0.070 | 0.104 | 0.034 | 0.26 | 11.9 | 0.55 | 0.38 |
| Example 18 | 66.2 | 0.069 | 0.130 | 0.061 | 0.47 | 15.1 | 0.39 | 0.27 |
| Example 19 | 80.7 | 0.085 | 0.104 | 0.019 | 0.15 | 9.9 | 0.92 | 0.31 |
| Example 20 | 90.4 | 0.084 | 0.130 | 0.046 | 0.35 | 12.4 | 0.53 | 0.28 |
| Example 21 | 80.5 | 0.084 | 0.156 | 0.072 | 0.55 | 14.9 | 0.47 | 0.26 |
| Example 22 | 83.0 | 0.092 | 0.156 | 0.064 | 0.50 | 14.5 | 0.43 | 0.27 |
| Example 23 | 74.0 | 0.085 | 0.156 | 0.071 | 0.55 | 16.2 | 0.43 | 0.31 |
| Example 24 | 82.1 | 0.063 | 0.130 | 0.067 | 0.51 | 12.2 | 0.67 | 0.33 |

According to various embodiments, an energy storage device comprises a positive electrode comprising a first activated carbon material and a negative electrode comprising a second activated carbon material. The first activated carbon material comprises pores having a size of ≦1 nm, which provide a combined pore volume of >0.3 cm³/g, pores having a size of >1 nm to ≦2 nm, which provide a combined pore volume of ≧0.05 cm³/g, and <0.15 cm³/g combined pore volume of any pores having a size of >2 nm. The second activated carbon material comprises pores having a size of ≦1 nm, which provide a combined pore volume of ≦0.3 cm³/g, pores having a size of >1 nm to ≦2 nm, which provide a combined pore volume of ≧0.05 cm³/g, and <0.15 cm³/g combined pore volume of any pores having a size of >2 nm. In embodiments, the first activated carbon material includes at most 1.5 wt. % oxygen, e.g., at most 1 or 0.5 wt. % oxygen. In related embodiments, each of the first activated carbon material and the second activated carbon material includes at most 1.5 wt. % oxygen, e.g., at most 1 or 0.5 wt. % oxygen. For instance, the activated carbon can have an oxygen content of from 1000 ppm to 1.5 wt. %, e.g., 1000, 2000, 5000, 10000 or 15000 ppm, including ranges between any of the foregoing values.

In embodiments, the activated carbon can be characterized by a high surface area. A carbon-based electrode for an EDLC can include carbon having a specific surface area greater than about 300 m²/g, i.e., greater than 300, 350, 400, 500 or 1000 m²/g. Further, the activated carbon can have a specific surface area less than 2500 m²/g, i.e., less than 2500, 2000, 1500, 1200 or 1000 m²/g.

The activated carbon can comprise micro-, meso- and/or macroscale porosity. As defined herein, microscale pores have a pore size of 2 nm or less. Mesoscale pores have a pore size ranging from 2 to 50 nm. Macroscale pores have a pore size greater than 50 nm. In an embodiment, the activated carbon comprises a majority of microscale pores. The term “microporous carbon” and variants thereof means an activated carbon having a majority (i.e., at least 50%) of microscale pores. A microporous, activated carbon material can comprise greater than 50% microporosity (e.g., greater than 50, 55, 60, 65, 70, 75, 80, 85, 90 or 95% microporosity).

According to embodiments, a carbon-based electrode for an EDLC comprises activated carbon having a total porosity greater than about 0.4 cm³/g (e.g., greater than 0.4, 0.45, 0.5, 0.55, 0.6, 0.65 or 0.7 cm³/g). The portion of the total pore volume resulting from micropores (d≦2 nm) can be about 90% or greater (e.g., at least 90, 94, 94, 96, 98 or 99%) and the portion of the total pore volume resulting from ultramicropores (d≦1 nm) can be about 50% or greater (e.g., at least 50, 55, 60, 65, 70, 75, 80, 85, 90 or 95%).

The pore size distribution of the activated carbon can include ultramicropores, micropores, mesopores and macropores and may be characterized as having a unimodal, bimodal or multi-modal pore size distribution. The ultramicropores can comprise 0.2 cm³/g or more (e.g., 0.2, 0.25, 0.3, 0.35 or 0.4 cm³/g or more) of the total pore volume. Pores having a pore size (d) in the range of 1<d≦2 nm can comprise 0.05 cm³/g or more (e.g., at least 0.1, 0.15, 0.2 or 0.25 cm³/g) of the total pore volume. If present, any pores having a pore size greater than 2 nm, which may include mesopores and/or macropores, can comprise 0.15 cm³/g or less (e.g., less than 0.1 or 0.05 cm³/g) of the total pore volume. In an embodiment, the activated carbon material comprises pores having a size of ≦1 nm, which provide a combined pore volume of >0.2 cm³/g, pores having a size from >1 nm to ≦2 nm, which provide a combined pore volume of ≧0.05 cm³/g, and <0.15 cm³/g combined pore volume of any pores having a size of >2 nm.

FIG. 3A is a schematic illustration of an example ultracapacitor. Ultracapacitor 10 includes an enclosing body 12, a pair of current collectors 22, 24, a first carbon mat 14 and a second carbon mat 16 each respectively formed over one of the current collectors, and a porous separator layer 18. Electrical leads 26, 28 can be connected to respective current collectors 22, 24 to provide electrical contact to an external device. Layers 14, 16 may comprise activated carbon, carbon black and high molecular weight fluoropolymer binder. A liquid electrolyte 20 is contained within the enclosing body and incorporated throughout the porosity of both the porous separator layer and each of the porous electrodes. In embodiments, individual ultracapacitor cells can be stacked (e.g., in series) to increase the overall operating voltage.

The enclosing body 12 can be any known enclosure means commonly-used with ultracapacitors. The current collectors 22, 24 generally comprise an electrically-conductive material such as a metal, and commonly are made of aluminum due to its electrical conductivity and relative cost. For example, current collectors 22, 24 may be thin sheets of aluminum foil.

Porous separator 18 electronically insulates the electrodes from each other while allowing ion diffusion. The porous separator can be made of a dielectric material such as cellulosic materials, glass, and inorganic or organic polymers such as polypropylene, polyesters or polyolefins. In embodiments, a thickness of the separator layer can range from about 10 to 250 microns.

The electrolyte 20 serves as a promoter of ion conductivity, as a source of ions, and may serve as a binder for the carbon. The electrolyte typically comprises a salt dissolved in a suitable solvent. Suitable electrolyte salts include quaternary ammonium salts such as those disclosed in commonly-owned U.S. patent application Ser. No. 13/682,211, the disclosure of which is incorporated herein by reference. Example quaternary ammonium salts include tetraethylammonium tetraflouroborate ((Et)₄NBF₄) or triethylmethyl ammonium tetraflouroborate (Me(Et)₃NBF₄).

Example solvents for the electrolyte include but are not limited to nitriles such as acetonitrile, acrylonitrile and propionitrile; sulfoxides such as dimethyl, diethyl, ethyl methyl and benzylmethyl sulfoxide; amides such as dimethyl formamide and pyrrolidones such as N-methylpyrrolidone. In embodiments, the electrolyte includes a polar aprotic organic solvent such as a cyclic ester, chain carbonate, cyclic carbonate, chain ether and/or cyclic ether solvent. Example cyclic esters and chain carbonates have from 3 to 8 carbon atoms, and in the case of the cyclic esters include □-butyro-lactone, □-butyrolactone, □-valerolactone and □-valerolactone. Examples of the chain carbonates include dimethyl carbonate, diethyl carbonate, dipropyl carbonate, ethylene carbonate, methyl ethyl carbonate, methyl propyl carbonate and ethyl propyl carbonate. Cyclic carbonates can have from 5 to 8 carbon atoms, and examples include 1,2-butylene carbonate, 2,3-butylene carbonate, 1,2-pentene carbonate, 2,3-pentene carbonate and propylene carbonate. Chain ethers can have 4 to 8 carbon atoms. Example chain ethers include dimethoxyethane, diethoxyethane, methoxyethoxyethane, dibutoxyethane, dimethoxypropane, diethoxypropane and methoxyethoxypropnane. Cyclic ethers can have from 3 to 8 carbon atoms. Example cyclic ethers include tetrahydofuran, 2-methyl-tetrahydrofuran, 1,3-dioxolan, 1,2-dioxolan, 2-methyldioxolan and 4-methyldioxolan. A combination of two or more solvents may also be used.

Ultracapacitors may have a jelly roll design, prismatic design, honeycomb design, or other suitable configuration.

As examples, an assembled EDLC can comprise an organic liquid electrolyte such as tetraethylammonium tetrafluoroborate (TEA-TFB) or triethylmethylammonium tetrafluoroborate (TEMA-TFB) dissolved in an aprotic solvent such as acetonitrile.

In example embodiments, a positive electrode includes a first activated carbon material comprising pores having a size of ≦1 nm, which provide a combined pore volume of >0.3 cm³/g, pores having a size of >1 nm to ≦2 nm, which provide a combined pore volume of ≧0.05 cm³/g, and <0.15 cm³/g combined pore volume of any pores having a size of >2 nm. A negative electrode includes a second activated carbon material comprising pores having a size of ≦1 nm, which provide a combined pore volume of ≦0.3 cm³/g, pores having a size of >1 nm to ≦2 nm, which provide a combined pore volume of ≧0.05 cm³/g, and <0.15 cm³/g combined pore volume of any pores having a size of >2 nm.

Activated carbon incorporated into the positive electrode may, for example, comprise pores having a size of ≦1 nm, which provide a combined pore volume of >0.3 to 0.5 cm³/g. Such activated carbon may have pores having a size of >1 nm to ≦2 nm, which provide a combined pore volume of ≧0.2 cm³/g (e.g., 0.2 to 0.3 cm³/g), and <0.1 or <0.05 cm³/g combined pore volume of any pores having a size of >2 nm.

Activated carbon incorporated into the negative electrode may, for example, comprise pores having a size of ≦1 nm, which provide a combined pore volume of 0.2 to 0.3 cm³/g. Such activated carbon may have pores having a size of >1 nm to ≦2 nm, which provide a combined pore volume of ≧0.2 cm³/g (e.g., 0.2 to 0.3 cm³/g), and <0.1 or <0.05 cm³/g combined pore volume of any pores having a size of >2 nm.

In an example EDLC, the activated carbon incorporated into the positive electrode may have a combined pore volume associated with pores having a size of >1 nm to <2 nm that is less than the corresponding combined pore volume of such size pores for the activated carbon incorporated into the negative electrode (i.e. a tuned cell example). In a further example EDLC, the activated carbon incorporated into the positive electrode may have a combined pore volume associated with any pores having a size of >2 nm that is less than the combined pore volume of pores of such sized pores for the activated carbon incorporated into the negative electrode (i.e. a tuned cell example).

The total oxygen content of example activated carbon is at most 1.5 wt. %. By total oxygen content is meant the sum of all atomic and molecular oxygen in the carbon, including oxygen in oxygen-containing functional groups in and/or on the carbon.

### DEFINITIONS

“Electrochemical double layer capacitor,” “EDLC,” “supercapacitor,” “ultracapacitor,” and like terms refer to electrochemical capacitors having double layer capacitance and pseudocapacitance. “EDLC cell,” “EDLC button cell,” and like terms refer to an electrochemical double layer capacitor having, for example, a housing, and within or integral with the housing: two electrodes; a separator between the electrodes; an electrolyte in contact with the electrodes; and optionally two current collectors.

“Chemically bonded oxygen content” and like terms refer to oxygen that is attached to carbon via chemical bonds and excluding oxygen present as molecular oxygen, water, carbon dioxide, and other oxygen-containing gas molecules that are physically adsorbed on carbon.

“Pore volume” and like terms refer to the void volume within the activated carbon.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The composition and methods of the disclosure can include any value or any combination of the values, specific values, more specific values, and preferred values described herein, including explicit or implicit intermediate values and ranges.

The disclosure provides an energy storage device and methods for making and use of the device.

In embodiments, the present disclosure provides an electrode in an energy storage device, comprising: a first activated carbon, comprising: a surface area of from 1000 to 1700 m²/g; a pore volume from 0.3 to 0.6 cc/g; a chemically bonded oxygen content of 0.01 to 1.5 wt %; and a pH of from 7.5 to 10.

In embodiments, the first activated carbon can have, for example, at least one of: a surface area from 1300 to 1700 m²/g; a pore volume from 0.4 to 0.6 cc/g, a pH from 8 to 10; an oxygen content of 0.01 to 1 wt %; an initial specific capacitance of 80 F/cc to 120 F/cc, as measured in a symmetrical electrochemical double layer capacitor cell with an organic electrolyte; or a combination thereof. An organic electrolyte comprises a salt, for example, tetraethylammonium tetrafluoroborate (TEA-TBF), triethylmethylammonium tetrafluoroborate (TEMA-TFB), or some other commonly used electrolyte salt, dissolved in an organic solvent, for example, acetonitrile, propylene carbonate, or some other commonly used organic solvent; or a combination thereof by mixing two or more salts, two or more organic solvents, or both.

In embodiments, the energy storage device can be, for example, an electrochemical double layer capacitor having a durability characterized by maintaining at least 80% of initial capacitance, and a maximum 200% of initial equivalent series resistance (ESR) when held at 3V and 65° C. for 1500 hours.

In embodiments, in addition to the first activated carbon described above, the energy storage device can further comprise, for example: a housing, and within the housing: a positive and a negative electrode; a separator situated between the electrodes; an electrolyte; and optionally two current collectors.

In embodiments, the positive and the negative electrodes can be, for example, the same or different. In embodiments, the positive electrode and the negative electrode are the same, i.e., symmetrical. In embodiments, the positive electrode and the negative electrode both comprise the first activated carbon. In other embodiments, the positive and the negative electrode are different, i.e., unsymmetrical or assymetric. In embodiments, the positive electrode comprises the first activated carbon and the negative electrode comprises a second activated carbon, for example, commercially available YP-50F, that is different from the first activated carbon.

In embodiments, the present disclosure provides an activated carbon having basic surface functionalities and having a pH greater than 7, such as 7.5 to 10, 8 to 10, and 8 to 9.5, including intermediate values and ranges. The basic surface functionalities and pH properties are advantageous because acidic surface functionalities can be detrimental to the long-term durability of EDLC devices. Preferably, the first activated carbon of the disclosure can have a pH from 8 to 10, more preferably, the first activated carbon has a pH from 8 to 9, including intermediate values and ranges.

In embodiments, the present disclosure provides an activated carbon having a chemically bonded oxygen content of from 0.01 to 1.5 wt % based on the total weight of the first activated carbon. The low content of chemically bonded oxygen is advantageous because oxygen surface functionalities can be detrimental to the long-term durability of EDLC devices. Preferably, the disclosed activated carbon has an oxygen content of from 0.01 to 1.0 wt %, including intermediate values and ranges.

### Examples

The following Examples demonstrate making, use, and analysis of the disclosed activated carbon, electrode, and energy storage device, in accordance with the above general description and procedures.

In embodiments, the disclosure provides a general method of making the disclosed activated carbon. Specific details can be varied, for example, as mentioned in the Examples.

### Activated Carbon Preparation

In embodiments, wheat flour was carbonized at 800° C. in a retort furnace purged with N₂. The resulting char was milled to a fine powder with d₅₀ of about 5 microns. The char powder was mixed with a KOH powder at a desired ratio.

The char-KOH mixture was activated in a retort furnace purged with N₂.

A typical furnace cycle consisted of, for example, a ramp-up at a 150° C./hr to a desired activation temperature, soak for 2 hours, and an unassisted cool-down to 120° C.

Next, water vapor was introduced into the furnace by bubbling N₂ through hot (about 90° C.) water for 3 hours, and the furnace was allowed to cool unassisted to 70° C. or lower.

The activated material was successively washed and filtered with DI water, with a HCl solution, and with DI water until the pH of the filtrate matched the pH of the DI water. The washed activated carbon was finally heat treated in a retort furnace purged with 1 vol % H₂/N₂ mixture. The furnace was ramped at 150° C./hr to a desired heat treatment temperature, soaked for 2 hours, and allowed to cool unassisted to room temperature.

### Activated Carbon Sample Characterization

Activated carbon samples were characterized using N₂ adsorption on a Micrometrics ASAP 2420. Surface area was characterized by BET theory. Pore volume and pore size distributions were characterized using the Density Functional Theory (DFT), and were calculated from the adsorption isotherms. The pH of the activated carbon samples were measured according to ASTM D3838-05. The oxygen content (wt %) of the activated carbon samples was determined by elemental combustion analysis of vacuum dried samples according to ASTM D5622 and are listed in Table 1.

As used herein, the singular forms “a,” “an” and “the” include plural referents unless the context clearly dictates otherwise. Thus, for example, reference to an “oxygen-containing functional group” includes examples having two or more such “functional groups” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a carbon-based electrode that comprises activated carbon, carbon black and binder include embodiments where a carbon-based electrode consists of activated carbon, carbon black and binder and embodiments where a carbon-based electrode consists essentially of activated carbon, carbon black and binder.

It will be apparent to those skilled in the art that various modifications and variations can be made to the present invention without departing from the spirit and scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

The disclosure has been described with reference to various specific embodiments and techniques. However, it should be understood that many variations and modifications are possible while remaining within the scope of the disclosure.

What is claimed is:

1. An electrical double-layer capacitor for high-voltage operation at high operating temperatures, comprising:
a housing for the electrical double-layer capacitor;
carbon positioned in the housing, wherein the carbon is activated and includes pores, wherein the pores in part provide the carbon with a high surface area of at least 500 m²/g, wherein the carbon is a low-oxygen activated carbon having a positive amount of chemically-bonded oxygen content that is less than 1.5% by weight thereof;
electrolyte positioned in the housing, wherein the electrolyte is a low-operating temperature electrolyte having a solvent with a boiling point of less than 85° C. at atmospheric pressure at sea level;
wherein at an operating temperature of the electrical double-layer capacitor of 85° C. at sea level:
(A) the housing of the electrical double-layer capacitor has an internal pressure that is greater than the atmospheric pressure, and
(B) the electrical double-layer capacitor has a voltage output of at least 2.6 V.

2. The electrical double-layer capacitor of claim 1, wherein the electrolyte is a high-concentration electrolyte having a molar concentration of at least 1.0 M, thereby facilitating supply of free ions at the high operating temperatures.

3. The electrical double-layer capacitor of claim 1, wherein the high-concentration electrolyte has a molar concentration of at least 1.2 M, and wherein the low-oxygen activated carbon has a chemically-bonded oxygen content that is 0.7% by weight or less.

4. The electrical double-layer capacitor of claim 3, having a voltage output of at least about 2.7 V at an operating temperature of the electrical double-layer capacitor of 85° C. at sea level, and having a voltage output of at least 2.9 V at an operating temperature of the electrical double-layer capacitor of 65° C. at sea level.

5. The electrical double-layer capacitor of claim 4, having at least about 70% of initial capacitance and no more than 200% of initial equivalent series resistance after 1500 hours of stress test at at least 2.9 V at 65° C. at sea level.

6. The electrical double-layer capacitor of claim 5, wherein the electrical double-layer capacitor has a beginning-of-life equivalent series resistance of about 0.5 mΩ or less at the voltage output of at least 2.6 V.

7. The electrical double-layer capacitor of claim 6, wherein the electrical double-layer capacitor has a beginning-of-life equivalent series resistance of about 0.3 mΩ or less at half of the voltage output of at least 2.6 V.

8. The electrical double-layer capacitor of claim 1, wherein the electrolyte comprises an electrolyte salt dissolved in an organic solvent, wherein the electrolyte salt comprises tetraethylammonium tetrafluoroborate or triethylmethylammonium tetrafluoroborate.

9. The electrical double-layer capacitor of claim 8, wherein the organic solvent comprises acetonitrile.

10. An electrical double-layer capacitor for high-voltage operation at high operating temperatures, the electrical double-layer capacitor comprising:
a housing for the electrical double-layer capacitor;
carbon positioned in the housing, wherein the carbon is activated and includes pores, wherein the pores provide the carbon with a high surface area of at least 500 m²/g, and wherein the carbon is a low-oxygen activated carbon having a positive amount of chemically-bonded oxygen content that is less than 1.5% by weight thereof;
electrolyte positioned in the housing, wherein the electrolyte is a low-operating temperature electrolyte having a solvent with a boiling point of less than 85° C. at atmospheric pressure at sea level, and wherein the electrolyte is a high-concentration electrolyte having a molar concentration of at least 1.0 M;
wherein at an operating temperature of the electrical double-layer capacitor of 85° C. at sea level:
(A) the housing of the electrical double-layer capacitor has an internal pressure that is greater than the atmospheric pressure, and
(B) the electrical double-layer capacitor has a voltage output of at least 2.6 V; and
wherein at an operating temperature of the electrical double-layer capacitor of 65° C. at sea level the electrical double-layer capacitor has a voltage output of at least 2.9 V.

11. The electrical double-layer capacitor of claim 10, having at least about 70% of initial capacitance and no more than 200% of initial equivalent series resistance after 1500 hours of stress test at at least 2.9 V at 65° C. at sea level.

12. The electrical double-layer capacitor of claim 10, wherein the electrical double-layer capacitor has a beginning-of-life equivalent series resistance of about 0.5 mΩ or less at the voltage output of at least 2.6 V.

13. An electrical double-layer capacitor for high-voltage operation at high operating temperatures, comprising:
a housing for the electrical double-layer capacitor;
carbon positioned in the housing, wherein the carbon is activated and includes pores, wherein the pores provide the carbon with a high surface area of at least 500 m²/g, and wherein the carbon is a low-oxygen activated carbon having a positive amount of chemically-bonded oxygen content that is less than 1.5% by weight thereof;
electrolyte positioned in the housing, wherein the electrolyte comprises an electrolyte salt dissolved in an organic solvent, wherein the electrolyte salt comprises tetraethylammonium tetrafluoroborate or triethylmethylammonium tetrafluoroborate;
wherein at an operating temperature of the electrical double-layer capacitor of 85° C. at sea level:
(A) the electrical double-layer capacitor has a voltage output of at least 2.6 V, and
(B) the electrical double-layer capacitor has a beginning-of-life equivalent series resistance of about 0.5 mΩ or less at the voltage output of at least 2.6 V.

14. The electrical double-layer capacitor of claim 13, wherein the electrical double-layer capacitor has a beginning-of-life equivalent series resistance of about 0.3 mΩ or less at half of the voltage output of at least 2.6 V.
